(19) United States
(12) Patent Application Publication
(10) Pub. No.: US 2025/0033006 A1
(43) Pub. Date: Jan. 30, 2025

(54) Mixing Conveyor For An Injection Moulding System, Injection Moulding System, Method For Producing A Moulded Article, And Moulded Article

(71) Applicant: Dornier LiteTech GmbH, München (DE)

(72) Inventor: Christian Platzer, Graz (AT)

(21) Appl. No.: 18/704,840

(22) PCT Filed: Nov. 3, 2022
(86) PCT No.: PCT/EP2022/080728

§ 371 Date: Apr. 25, 2024

(30) Foreign Application Priority Data
Nov. 3, 2021 (WO) PCT/EP2021/080517

(51) Int. Cl. B01F 23/60; B01F 23/80; B01F 27/112; B01F 27/1143; B01F 29/25; B01F 33/40; B01F 35/71; B01F 101/45; B22F 1/12; B22F 3/00; B22F 3/22; C22C 23/02

(52) U.S. Cl. CPC B01F 23/69; B01F 23/811; B01F 27/112; B01F 27/1143; B01F 29/25; B01F 33/401; B01F 33/402; B01F 33/404; B01F 35/7179; B22F 1/12; B22F 3/003; B22F 3/225; C22C 23/02; B01F 2101/45; B01F 2215/044; B01F 2215/0477; B01F 2215/0481; B22F 2301/058; B22F 2302/40; B22F 2998/10; B22F 2999/00

(57) ABSTRACT

The invention relates to a mixing conveyor for an injection molding system, in particular a thixomolding injection molding system, or the like for conveying a granule-powder mixture, comprising the following:
a mixing container (10), with at least one feed (11, 13) for granular material (12) and/or powdery material (14); and
at least one mixing device (13a, 13b, 13c, 13d) which is designed to mix the granular material (12) and the powdery material (14) to form a granule-powder mixture; and
a mixing container outlet (15), which can be arranged in particular in the vicinity of a melting area (51) of the injection molding system (50) or the like, and is designed to discharge the granule-powder mixture or to feed it to the injection molding system (50) or the like for at least partial melting.

The present invention relates to a mixing conveyor for an injection molding system according to the subject matter of claim 1, a corresponding injection molding system according to the subject matter of claim 10, a method for producing a molded article according to the subject matter of claim 11, and a molded article according to the subject matter of claim 25.

Components are regularly made from aluminum for a wide range of applications, such as in aviation or the automotive industry, as the comparatively low density of aluminum makes it possible to produce comparatively lightweight components in order to save weight.

Magnesium has a density that is approximately 1.55 times lower than the density of aluminum. This makes magnesium a highly interesting material for lightweight components. Despite this advantageous property of low density, conventional magnesium alloys are still relatively unconsidered for the production of components for applications such as in aviation or the automotive industry. On the one hand, this is due to the relatively high reactivity of magnesium and the associated comparatively low ignition temperature, as this naturally represents an increased and therefore often undesirable hazard potential. On the other hand, components made of conventional magnesium alloys sometimes have disadvantageous mechanical properties, such as lower tensile strength and lower elongation at break, than comparable components made of aluminum (alloys).

Various approaches already exist in the prior art to increase the ignition temperature of a magnesium alloy by means of appropriate material compositions and thus provide “flame-resistant” magnesium alloys. However, there is still a great need to optimize the mechanical properties of magnesium alloys.

To improve the mechanical properties of a magnesium alloy, DE 11 2012 001 625 B4 proposes, for example, coating a surface of magnesium alloy chips with carbon powder and using these coated chips for injection molding. However, this method provides only a limited carbon content in the alloy or in a corresponding molded article, since the chips for injection molding provide only a finite surface area and the absorption capacity of this surface is limited. If the carbon content in the method of DE 11 2012 001 625 B4 is more than 3% by weight, the carbon powder can possibly clump together, which leads to cracking and consequently causes a variation in the tensile strength of a molded article. The carbon content of the conventional alloy according to DE 11 2012 001 625 B4 is therefore preferably 0.5% by weight or less. Moreover, in the method proposed in the prior art, the carbon content (or the content of another powder) to be introduced into the alloy of the molded article is dependent on the shape of the chips, since—depending on the shape of the chips—a ratio of surface area to volume of a single particle of the chips is not linear. Thus, with such a method, it is not possible to make a sufficiently accurate setting of a mixing ratio of a desired alloy in percent by weight (wt. %), since in the case of coating, the amount of carbon (or other powder to be incorporated) depends on the surface/volume ratio of the chips. Apart from this, powder-coated chips also have the disadvantage that the chips and powder inevitably segregate during transportation and/or storage, so that they can no longer (or only poorly) be processed (or would have to be remixed, wherein a customer may not have a device intended for this purpose).

In the light of the above, the object of the present invention is to provide a process- and/or plant-technical possibility for producing an (injection-molded) molded article which is characterized by low technical complexity, is inexpensive and improves the mechanical properties of a molded article. It is a further object of the invention to provide the molded article which overcomes the above-mentioned disadvantages and has improved mechanical properties and a high ignition resistance.

The object is solved by a mixing conveyor for an injection molding system with the features of claim 1, an injection molding system with the features of claim 10, a method for producing an alloy with the features of claim 11 and a molded article made of the alloy according to the invention with the features of claim 25. Advantageous further embodiments result from the subclaims.

The object of the invention is solved in particular by a mixing conveyor for an injection molding system, in particular a thixomolding injection molding system, or the like for conveying a granule-powder mixture, comprising the following:
a mixing container, with at least one feed for granular material and/or powdery material; and
at least one mixing device which is designed to mix the granular material and the powdery material to form a granule-powder mixture; and
a mixing container outlet, which can be arranged in particular in the vicinity of a melting area of the injection molding system or the like, and is designed to discharge the granule-powder mixture or to feed it to the injection molding system or the like for at least partial melting.

An important idea of the invention is to provide a possibility for the process-technical and plant-technical production of a molded article from an alloy which has a high tensile strength and a high yield strength. With a coating process of chips for injection molding, as proposed in the prior art, this was not possible in a process-stable manner. Accordingly, a method as well as a mixing conveyor for injection molding systems or the like is hereby provided which achieves a higher proportion of powdery material (e.g. carbon or carbon-based compounds) through a “just in time composition” strategy. Here, the granulate is mixed with the powder directly at the inlet of the injection or dosing cylinder of an injection molding system or the like. Coating or adhesion of powder to the granulate is not necessary or desirable. A homogeneous distribution of the powder in the overall alloy is only achieved by processing the granule-powder mixture directly before/during melting. The limits of adhesion/coating due to a limited surface area of the granulate no longer play a role in this way, as no segregation of the granule-powder mixture can occur due to the temporal and spatial proximity to the melting area. In addition, the “just-in-time composition” strategy proposed here—i.e. mixing the powdery material and the granular material directly in or at the mixing conveyor-offers a logistical advantage, as mixing during processing does not result in any disadvantages due to transportation or storage (as is the case with the pre-coated material from the prior art).

In the context of this application, a granulate or granular material is understood to be a granular (metallic) solid with an average grain size of between 0.5 and approx. 10 mm. The granules can be present in various geometries. For example, chips or the like or also lenticular or drop-shaped granules are conceivable. Chips (granulate chips) can be obtained, for example, by shredding (pre-cast) ingots. In addition, it is conceivable to obtain lenticular granules by dripping from a melting pot (e.g. by dropping the drops onto a cold plate) or to produce drop-shaped granules by dripping from the melting pot (e.g. by free fall and solidification in a high tower or the like). The advantage of such dripping is that the alloy is the same in every drop, i.e. it is particularly homogeneous. An average grain size is understood here to be a size determined by sieve analysis which corresponds to a sieve passage of 50%. In particular, the granular material can have average particle sizes of between 1 and 2 mm or between 2 and 3 mm or between 3 and 4 mm or mixtures of these particle sizes. The particles of the granules used here typically have an essentially cuboid shape with a length-to-width ratio of between 1 and 10, preferably between 1 and 7, more preferably between 1 and 3.

In the context of this application, a powder or powdery material is understood to mean material with a smaller particle size than granules. In particular, this is understood to mean particle diameters of less than 1000 nm, 500 nm, preferably less than 250 nm, more preferably less than 100 nm or less than 25 nm.

In the context of the present application, the “vicinity” of the arrangement of the mixing container outlet to the melting area is to be understood in particular to mean that the distance which the granule-powder mixture has to cover here is kept short, in particular such that the granule-powder mixture can cover this distance in a time of less than 120 seconds, preferably less than 60 seconds, more preferably less than 30 seconds, so that in particular no or essentially no segregation of the granule-powder mixture can occur.

The present application is intended to provide a mixing conveyor preferably for a thixomolding injection molding system. In principle, however, the mixing conveyor according to the invention can also be used for other injection molding processes which use metallic granules (i.e. also non-magnesium-based granules) as starting material.

A mixing container is a container in which the materials are mixed or which has one or more mixing device(s) for mixing the materials or which is connected to one or more such mixing device(s) in order to receive the materials mixed by the mixing device(s).

In the context of this application, a mixing device is understood to be a device which mixes the materials to be mixed together or mixes them underneath each other by means of a repetitive movement or mixing movement (similar to baking), in particular in order to mix the materials together as homogeneously as possible. A (homogeneous) mixture is understood to mean that the powdery material is evenly distributed between the granular material.

In one embodiment, the mixing device or the mixing conveyor is designed to mix the granular material and the powdery material into a granule-powder mixture by means of a repetitive movement or mixing movement of the granular material and the powdery material. As a result, the powdery material in the granules is submerged (similar to baking) and a homogeneous granule-powder mixture can be produced. This makes it possible to mix granules and powder with a comparatively high accuracy of the mixing ratios. In particular, this method enables an accuracy of ±0.05 percent by weight of the powder content.

In one embodiment, the mixing device is designed to mix the granular material and the powdery material by means of a gas-induced flow to form a granule-powder mixture. For example, the mixing device can be arranged as a (gas) nozzle on the mixing container in such a way that a gas flow is directed into the interior of the mixing container. This allows a homogeneous mixture of the granule-powder mixture to be produced by means of an introduced (turbulent) flow, which can be controlled in a process-stable manner via a gas flow. Either the powdery material (directed onto the granular material) can be injected (flow-induced mixing, as described below) or a gas flow (e.g. air) can be directed onto the granule-powder mixture inside the mixing container using a nozzle so that it is set in turbulent motion to counteract segregation.

In a preferred embodiment, the mixing conveyor has the following features in particular:
a mixing container which has a first feed for granular material and a second feed for powdery material;
wherein the second feed has at least one powder feed nozzle (as a mixing device) which is designed to inject the powdery material into the mixing container in such a way that a flow-induced granule-powder mixture can be produced in the mixing container; and
a mixing container outlet, which can be arranged in particular in the vicinity of a melting area of the injection molding system or the like, and is designed to discharge the granule-powder mixture or to feed it to the injection molding system or the like for at least partial melting.

In other words, the mixing device comprises a powder feed nozzle, wherein the mixing container has a first feed for granular material and a second feed for powdery material, wherein the second feed has the powder feed nozzle, and wherein the powder feed nozzle is designed in particular to inject the powdery material into the mixing container in such a way that a flow-induced granule-powder mixture can be produced in the mixing container in order to mix the granular material and the powdery material with one another.

Mixing in the mixing conveyor by “spraying” the powder against a flow of granules has proven to be particularly suitable. As a result, the present invention offers the possibility of an exact or precise adjustment of the amount of powdery material to be incorporated into the alloy (in wt. %) by injecting and the associated mixing. This is particularly advantageous for larger granules. This allows mixing to take place immediately before feeding into the melting area of the screw conveyor (or the melt mixer, e.g. also Rheo Casting), so that homogeneity at/in the melting area is ensured in order to optimize the (mechanical) properties of the molded article to be produced.

In the context of this application, the powder feed nozzle or the associated process of injection or spraying means that the powder is injected through a small opening (nozzle) of the powder feed nozzle by means of pressure into the interior of the mixing container and sprayed in the process. The pressurized gas or gas mixture used for this purpose provides the necessary flow and turbulence of the atmosphere for the (flow-induced) mixing of the granules and the powder in the mixing container of the mixing conveyor.

In one embodiment, the second feed is arranged in a lower region of the mixing container in the vicinity of the mixing container outlet.

As a result, the granule-powder mixture has to travel a (very) short or minimal distance to the melting area, so that no segregation or clumping can occur due to the temporal or spatial proximity (from mixing of the mixture to the melting area).

In one embodiment, the first feed and the second feed are aligned relative to one another in such a way that a feed flow line L₁₂ for the granular material and a feed flow line L₁₄ for the powdery material run inside the mixing container at an angle θ to each other. Alternatively or additionally, the second feed or the at least one powder feed nozzle can be aligned such that a feed flow line L₁₄ for the powdery material runs tangentially to a circumference of the mixing container.

This enables the granular material to be swirled by the powdery material hitting the granules or a stream of granules (from the side). In this way, the granular material and the powdery material mix particularly homogeneously.

In a further embodiment, a plurality of powder feed nozzles are arranged uniformly, in particular annularly, in the circumferential direction of the mixing container and/or are arranged uniformly, in particular annularly, distributed around a feed flow line of the granular material.

On the one hand, this can increase the feed rate (quantity per time) of powdery material and, on the other hand, homogenization of the granule-powder mixture can be increased in a particularly advantageous way or clumping and/or segregation can be counteracted, as the sprayed powdery material can act on or impact a stream of granular material from all sides (for example from 4 or 8 sides).

In one embodiment, means are provided for controlling a feed rate of the powdery material and/or the granular material, preferably the feed rate is enabled by pressurization or purging with a gas or a gas mixture.

The mixing of the granule-powder mixture can be influenced by controlling the feed speed. For example, a feed speed of the powdery material can be adjusted depending on the weight of the granular material, so that a sufficiently high or advantageously high impact of powder on granules occurs in the mixing container in order to achieve the most homogeneous (flow-induced) mixing of the granule-powder mixture possible.

In one embodiment, the means for controlling a feed speed of the powdery material and/or the granular material are designed to generate a controllable relative speed between 0.5 m/s to 500 m/s, preferably 1 m/s to 200 m/s, preferably between 10 m/s to 100 m/s between a granular feed flow and a powder feed flow within the mixing container.

These relative speeds have proven to be particularly practicable, so that a high degree of homogenization of a granule-powder mixture is achieved and no segregation or clumping occurs in the melting area, so that ultimately a homogeneous melt is achieved, wherein the powdery material does not float on the melt, but is homogeneously distributed in the melt.

In one embodiment, the mixing device is designed to mix the granular material and the powdery material into a granule-powder mixture by means of a rotational movement. In this way, mixing can also take place immediately before the material is fed into the melting area of the extruder (or the melt mixer, e.g. also rheo casting), so that homogeneity of the granule-powder mixture at/in the melting area is ensured in order to optimize the (mechanical) properties of the molded article to be produced.

In one embodiment, the mixing device (for mixing by a rotational movement) comprises a feed screw which is designed to receive the granular material and the powdery material and to mix them to form a granule-powder mixture. This allows (in addition to the above-mentioned homogeneity of the mixture in/at the melting area) a comparatively high accuracy in setting the ratio of the powder to the granules. In particular, an accuracy of ±0.05 percent by weight of the powder content is achieved, so that the alloy to be produced or the molded article made from it has optimized (mechanical) properties.

In one embodiment, the mixing device (for mixing by a rotational movement) comprises a drum mixer which is designed to receive the granular material and the powdery material and to mix them to form a granule-powder mixture. This allows (in addition to the above-mentioned homogeneity of the mixture in/at the melting area) a comparatively high accuracy in setting the ratio of the powder to the granules. In particular, an accuracy of ±0.05 percent by weight of powder content is achieved, so that the alloy to be produced or the molded article made from it has optimized (mechanical) properties.

In one embodiment, the mixing device (for mixing by a rotational movement) comprises a homogenizing device which is arranged inside the mixing container and which is designed to homogenize the contents of the mixing container, preferably by rotating a stirring blade or a stirring hook or the like.

A homogenizing device is a device that counteracts agglomeration or clumping of the materials and increases the homogeneity of the mixture. In particular, this should be understood to mean a type of “mixer” that mixes the materials. The homogenizing device can, for example, be formed by stirring hooks or stirring blades.

The homogenization device inside the mixing container homogenizes the homogeneity of the granule-powder mixture (possibly in addition to other mixing devices) immediately before or directly in the vicinity of the melting area (optionally again). This makes it possible to further optimize the (mechanical) properties of the alloy or the molded article produced from it.

The object of the invention is further solved by an injection molding system (for (light) metal alloys), preferably a thixomolding injection molding system, comprising a mixing conveyor as described above, wherein the mixing container outlet of the mixing conveyor is arranged in the vicinity of a melting area of the injection molding system and is designed such that the granule-powder mixture can be melted immediately after mixing and/or at least partially during mixture.

With the injection molding system according to the invention, the same advantages can be achieved as those already described in connection with the mixing conveyor according to the invention. It should be noted that the features described in the context of the mixing conveyor according to the invention also apply to the injection molding system according to the invention. Features of the mixing conveyor, in particular the means for adjusting the feed rate(s) of powdery and/or granular material, are transferable to the injection molding system according to the invention, which may alternatively have these features.

The injection molding system is preferably designed to mix the granule-powder mixture in a flow-induced manner (i.e. induced by the powder feed nozzles of the mixing container) or by a rotational movement (e.g. by a drum mixer or a feed screw) and (subsequently and/or simultaneously) by a movement of the screw of the injection molding system, in particular in such a way that the granule-powder mixture is/remains in constant motion (up to the melting area). Due to the proximity of the location of the mixing of powdery and granular material or the mixing container outlet and the melting area of the injection molding system, there is no segregation or clumping of the granule-powder mixture in the melting area. In this way, the granule-powder mixture (depending on the feed speeds) can be (at least partially) melted in a moving state, so that a homogeneous melt is achieved and the powdery material does not float on the melt, but is homogeneously distributed in the melt.

The object of the invention is further solved by a method for producing a molded article preferably by means of thixomolding, comprising the following steps of:
a) carrying out a mixing process in which at least one granular material comprising magnesium and/or aluminum or an alloy thereof and at least one powdery material is mixed in a mixing device to form a granule-powder mixture;
b) feeding the granule-powder mixture into a mixing container of the injection molding system;
c) at least partial melting of the granule-powder mixture in a melting area;
d) injection molding of the molded article from the at least partially melted granule-powder mixture.

With the method according to the invention, the same advantages can be achieved as those already described in connection with the mixing conveyor according to the invention or the injection molding system according to the invention. It should also be noted that the features described in the context of the mixing conveyor according to the invention also apply to the method according to the invention. Features of the mixing conveyor are transferable to the method according to the invention. Likewise, features of the method according to the invention are transferable to the mixing conveyor according to the invention or to the injection molding system according to the invention by configuring the mixing conveyor or the injection molding system in such a way that it is suitable for carrying out the corresponding method features. Moreover, an important point of the present invention is to provide a molded article by this manufacturing method.

In one embodiment of the method, the granular material and the powdery material are mixed in step a) and/or b) by a repetitive movement of the granular material and the powdery material to form a granule-powder mixture. As a result, the powdery material is submerged in the granules (similar to baking) and a homogeneous granule-powder mixture can be produced, which also makes it possible to mix granules and powder with a comparatively high accuracy of the mixing ratios. In particular, this method enables an accuracy of ±0.05 percent by weight of the powder content.

In one embodiment of the method, the time between (the end of) step a) and (the beginning of) step c) is at most 120 seconds, preferably at most 60 seconds. This ensures that no or no significant segregation of the granule-powder mixture can occur (e.g. due to the influence of gravity or other forces or influences). Overall, the shorter the time intervals, the more homogeneously the powder is distributed in the granules and the more homogeneous the granule-powder mixture is in the melting area. In this respect, the comparatively short time between mixing and melting can improve the mechanical properties of the molded article.

In one embodiment of the method, steps a) and b) are carried out (substantially) simultaneously, wherein the powdery material is injected into the mixing vessel, or into at least a portion of the mixing vessel, for flow-induced mixing of the powdery material with the granular material using at least one powder feed nozzle. In this embodiment, the steps of the method could also be formulated as follows:
a′) feeding at least a first granular material comprising magnesium and/or aluminum or an alloy thereof into a mixing container of an injection molding system, in particular as described above;
b′) injecting (spraying) powdery material into the mixing container or into at least one section of the mixing container for mixing the powdery material with the at least one first granular material to form a granule-powder mixture;
c′) at least partial melting of the granule-powder mixture in a melting area;
d′) injection molding of the molded article from the at least partially melted granule-powder mixture.

In one embodiment, a relative feeding speed between the granular material and the powdery material is between 0.5 m/s and 500 m/s, preferably between 1 m/s and 200 m/s, more preferably between 10 m/s and 100 m/s.

These relative speeds have proven to be particularly practicable, so that both a high degree of homogenization of a granule-powder mixture was achieved and that no segregation or clumping occurs in the melting area, so that a homogeneous melt is achieved and the carbon powder does not float on the melt, but is homogeneously distributed in the melt. Depending on the weight and/or density of the granules and/or powder, slightly different relative speeds may be advantageous. As a rule, a relative speed of less than 50 m/s is advantageous.

In one embodiment, the powdery material is injected (sprayed) against a flow of granular material and/or at an angle θ to the flow of granular material.

This enables the granular material to be swirled by the powdery material hitting the granules or a stream of granules (from the side). In addition, the powder flow is directed towards the granule flow from below. In this way, the granular material and the powdery material mix particularly homogeneously.

In one embodiment of the method, the powdery material and the granular material are mixed in step b) and/or step a) in a feed screw conveyor. This allows (in addition to the above-mentioned homogeneity of the mixture in/at the melting area) a comparatively high accuracy in setting the ratio of the powder to the granules. In particular, an accuracy of ±0.05 percent by weight of the powder content can be achieved, so that the alloy to be produced or the molded article made from it has optimized (mechanical) properties.

In one embodiment of the method, the powdery material and the granular material are mixed in step b) and/or step a) in a drum mixer. This allows (in addition to the above-mentioned homogeneity of the mixture in/at the melting area) also a comparatively high accuracy of the adjustment of the ratio of the powder to the granules. In particular, an accuracy of ±0.05 percent by weight of the powder content can be achieved, so that the alloy to be produced or the molded article made from it has optimized (mechanical) properties.

In one embodiment of the method, the powdery material and the granular material are mixed in step b) and/or step a) with a homogenizing device inside the mixing container. The homogenizing device inside the mixing container homogenizes the homogeneity of the granule-powder mixture (optionally in addition to other mixing devices) immediately before or directly in the vicinity of the melting area (optionally again). This makes it possible to further optimize the (mechanical) properties of the alloy or the molded article produced from it.

In one embodiment of the method, the mixing process comprises an external mixing process outside the mixing container and a second internal mixing process inside the mixing container. This makes it possible to counteract any (albeit slight) segregation of the granule-powder mixture that may have already occurred and to (re) homogenize it. As a result, the granule-powder mixture is homogenized again or further immediately before or directly in the vicinity of the melting area. This makes it possible to further optimize the (mechanical) properties of the alloy or the molded article produced from it.

In one embodiment of the method, step c) immediately follows step a) and/or b). Alternatively or additionally, steps a) to c) are carried out (substantially) simultaneously for corresponding partial quantities of the granule-powder mixture. Preferably, according to one embodiment, the granule-powder mixture reaches the melting area in a (constantly) moving state and is at least partially melted there.

Due to the immediate succession or simultaneity of a flow-induced movement (or mixing) of the granule-powder mixture and a movement (or mixing) of the granule-powder mixture by the screw, there is no segregation or clumping of the granule-powder mixture in the melting area, since the granule-powder mixture is (directly) melted (at least partially) in a moving state. In this way, a particularly homogeneous melt is achieved.

In one embodiment, the powdery material comprises carbon or carbon powder or mixtures of different carbon powders or carbon compounds. The carbon may be present in powder form as (non-exhaustive) pure carbon, CNT, graphene, graphite, or mixtures thereof. Particularly preferably, the powdery material comprises a mixture of carbon powders, with a first proportion of FW 171 carbon particles (11 nm mean particle size of the primary particles) and a second proportion of Printex 60 carbon particles (21 nm mean particle size of the primary particles). These two proportions are particularly preferably present in a ratio of 50:50. A carbon compound can be present in powder form as (non-exhaustive) C₂Cl₆, carbides such as Al₄C₃, SiC, TiC, or mixtures thereof.

In alternative embodiments, the powdery material may also comprise borides (such as TiB₂, NbB₂) (for example, in addition to or instead of carbon or carbon compounds). It has been shown that these materials (as well as carbon or carbon compounds) have a grain refining effect and improve the material properties of the alloy.

In addition, other materials belonging to a desired alloy composition can also be added as powdery material. For example (in the case of the alloy explained in more detail below), calcium (Ca) can either be a component of the granular material or added to the powdery material in powder form. In this way, handling is comparatively flexible and material compositions can be precisely adjusted.

The use of carbon (powder) or other powdered carbon compounds (and/or borides) improves the mechanical properties of the molded article made from the (magnesium) alloy. The particles of the powder are distributed homogeneously in the melt and are then the starting point for the crystallization or solidification of the alloy. Due to the large number of nuclei (particles), a particularly fine grain is achieved in this way and the addition of the particles results in reduced porosity in the component, which has been proven in tests. In particular, this allows a high yield strength and/or a high elongation at break of the molded part to be achieved.

In one embodiment, the powdery material is injected (if a powder feed nozzle is provided) using pressurization of a gas, preferably argon, or gas mixtures.

The directed gas flow can homogenize the granule-powder mixture. In addition, the gas ((compressed) air, argon or similar) or the gas mixture (e.g. air and argon) can also prevent or at least reduce oxidation of the melt.

In one embodiment, the mixing process of step a) comprises the following:
Providing the granular material (12), wherein the granular material (12) comprises granules consisting of the following:
   1.0% by weight to 10% by weight aluminum (Al);
   0.1% by weight to 2.0% by weight calcium (Ca);
   0.05% by weight to 2.0% by weight yttrium (Y);
   optionally more than 0.0% by weight and up to 0.002% by weight beryllium (Be)
   optionally more than 0.0% by weight and up to 6.0% by weight zinc (Zn);
   optionally more than 0.0% by weight and up to 1.0% by weight manganese (Mn); and a balance of magnesium (Mg) and a balance of unavoidable impurities;
Providing the powdery material (14), wherein the powdery material comprises carbon powder (C), preferably in an amount between 0.1 to 5.0% by weight (further preferably 0.2% to 4.0% by weight, still more preferably 0.5% to 3.5% by weight) of the total weight of the components of powdery material (14) and granular material (12);
Mixing the granules and the carbon powder to form the granule-powder mixture.

In one embodiment, the powdery material has a particle size below 25 nm or between 10 and 25 nm, which has an advantageous effect on the grain refinement of the alloy and thus on the mechanical properties of the molded article.

The powdery material can, for example, comprise FW 171 carbon particles (11 nm average particle size of the primary particles) and/or Printex 60 carbon particles (21 nm average particle size of the primary particles). The comparatively small particle sizes are suitable for grain refinement of the alloy, which can increase the mechanical strength of the molded article or the alloy.

Particularly preferably, the powdery material comprises a mixture of carbon powders, with a first proportion of FW 171 carbon particles (11 nm average particle size of the primary particles) and a second proportion of Printex 60 carbon particles (21 nm average particle size of the primary particles). This further increases the mechanical properties of the molded article or the alloy. It is particularly preferred that these two proportions are present in a ratio of 50:50. This ratio further increases the mechanical properties of the molded article or alloy.

Overall, a mixing process with carbon powder produces a granule-powder mixture that is particularly suitable for producing a molded article as described below. The carbon powder has a grain-refining effect, so that the mechanical properties of the molded article or the alloy can be improved. In particular, a comparatively high tensile strength is achieved. The carbon powder also has a positive effect on the castability of the alloy. It has been observed that the carbon particles allow the screw (of the extruder) to rotate more smoothly. This reduces wear on the system and leads to greater process stability.

The object of the invention is further solved by a molded article of an alloy (or is solved by the alloy), which is preferably produced by a method as described above, wherein the molded article (by injection molding) consists of (or comprises) the following:
0.1% by weight to 5.0% by weight carbon (C), preferably 0.2% by weight to 4.0% by weight carbon (C), more preferably 0.5% by weight to 3.5% by weight carbon (C);
1.0% by weight to 10% by weight aluminum (Al);
0.1% by weight to 2.0% by weight calcium (Ca);
0.05% to 2.0% by weight of yttrium (Y);
optionally more than 0.0% by weight and up to 0.002% by weight of beryllium (Be);
optionally more than 0.0% by weight and up to 6.0% by weight zinc (Zn);
optionally more than 0.0% by weight and up to 1.0% by weight of manganese (Mn); and
a balance of magnesium (Mg) and a residue of unavoidable impurities.

An important point of the present invention is to provide the molded article by a manufacturing method as described above, or to provide the corresponding alloy. In this way, the (individual) alloy components (except the carbon portion) may be provided in one type or different types of granular material. The addition of carbon (and/or other grain refining powdery material) is provided by powdery material as described above. The use of carbon or carbon compounds (and/or other granular powdery material) improves the mechanical properties of the molded article. The particles of the (grain-refining) powder are distributed homogeneously in the melt and are then the starting point for the crystallization or solidification of the alloy. Due to the large number of nuclei (particles), a particularly fine grain is achieved in this way and the addition of the particles results in reduced porosity in the component, which has been proven in tests. In addition, the mechanical properties of the molded article made from the (magnesium) alloy are improved, wherein this can be achieved by reducing the porosity (casting defects) in the material and by refining the grain. Alternatively or in addition (to carbon or carbon compounds), other powdery materials can also be used. Depending on the composition of the granular material, the properties of the molded article can be optimized. The carbon can be present in powder form as (non-exhaustive) pure carbon, CNT, graphene, graphite or mixtures thereof. A carbon compound may be present in powder form as (non-exhaustive) C₂Cl₆, carbides such as Al₄C₃, SiC, TiC, or mixtures thereof. Alternatively or additionally, the powdery material may also comprise borides (such as TiB₂, NbB₂). It has been shown that these materials (as well as carbon or carbon compounds) have a grain-refining effect and improve the material properties of the alloy.

In particular, the addition of carbon (powder) can form aluminum carbides through the combination of carbon particles and aluminum, which lead to a grain refinement of the alloy. As a result, a high yield strength and/or a high elongation at break of the molded article can be achieved.

The addition of the grain-refining material (carbon powder) is also particularly advantageous where the highest mechanical requirements must be met with comparatively little available installation space (e.g. in aircraft components). One possibility that could be used here, for example, is to use non-constant wall thicknesses of the molded object in order to guarantee such requirements. However, this approach is comparatively disadvantageous and should tend to be avoided in casting. In the case of the alloy according to the invention, the carbon in the alloy has the advantage that the resulting grain refinement makes it easier to compensate for jumps in wall thickness and mass accumulations in the molded article, because fine grain is also achieved in thick areas of the molded article and more uniform, finely distributed or fewer gas inclusions are formed.

By adding approx. 1% by weight calcium (Ca) (and approx. 1% by weight yttrium (Y)), the ignition temperature of the magnesium alloy is increased by approx. 200° C. in each case, so that the fire resistance is also optimized as a result.

The (optional) addition of beryllium (Be) greatly reduces oxidation of the alloy. Even a few ppm have a major effect. This can increase both the ignition temperature and, optionally, the workability of the alloy.

The above-mentioned material composition has resulted in a molded article consisting of a magnesium alloy, which on the one hand has a high fire resistance and on the other hand has a high mechanical strength due to the carbon content. This molded article is therefore particularly suitable for lightweight components in the aerospace or automotive industry, for example battery housings or in other areas where weight reduction or weight saving is advantageous.

The same advantages as already described in connection with the method according to the invention can be achieved with the alloy or the molded article according to the invention. It should be noted that the features described in the context of the method according to the invention also apply to the alloy or molded article according to the invention. Features of the method are transferable to the alloy or molded article according to the invention (and vice versa).

In one embodiment, the alloy or the molded article has a tensile strength (Rₘ) of at least 210 MPa, preferably at least 220 MPa and/or an elongation at break (σ_{B}) of at least 3.5%, preferably at least 4%, more preferably at least 4.5%.

Here, the parameters were determined by means of tensile tests on tensile specimens (DIN6892-1). The elongation at break here indicates the elongation of tensile specimens after a break in relation to the initial length.

Due to the comparatively high tensile strength and the comparatively high elongation at break obtained by the grain refinement according to the invention, the molded article according to the invention with these properties can be used in many places that require high mechanical stability with comparatively low weight.

In the following, the invention is also described with regard to further details, features and advantages, which are explained in more detail with reference to the figures. The features and combinations of features described, as shown below in the figures of the drawing and described with reference to the drawing, are applicable not only in the combination indicated in each case, but also in other combinations or in an isolated position, without departing from the scope of the invention, wherein:

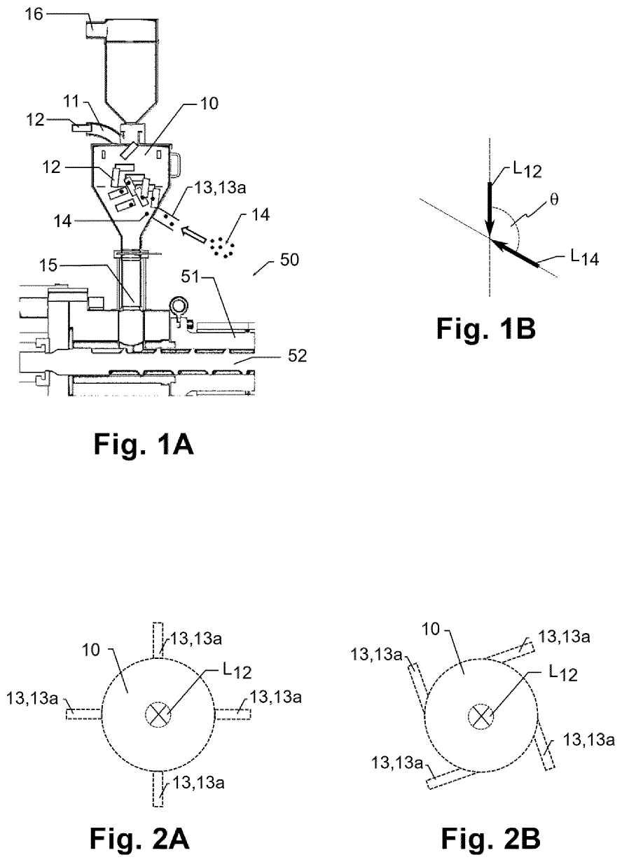

FIG. 1A shows a schematic sectional view of an exemplary embodiment of a mixing conveyor according to the invention with a powder feed nozzle and a corresponding injection molding system (only partially shown);

FIG. 1B shows a schematic representation to illustrate the relative arrangement of a feed flow line L₁₂ for granular material and a feed flow line L₁₄ for powdery material within the mixing container (from the exemplary embodiment according to FIG. 1A) at an angle θ;

FIG. 2A shows a schematic view of a mixing container according to an alternative exemplary embodiment with four powder feed nozzles;

FIG. 2B shows a schematic view of a mixing container according to a further exemplary embodiment with a tangential alignment of the four powder feed nozzles;

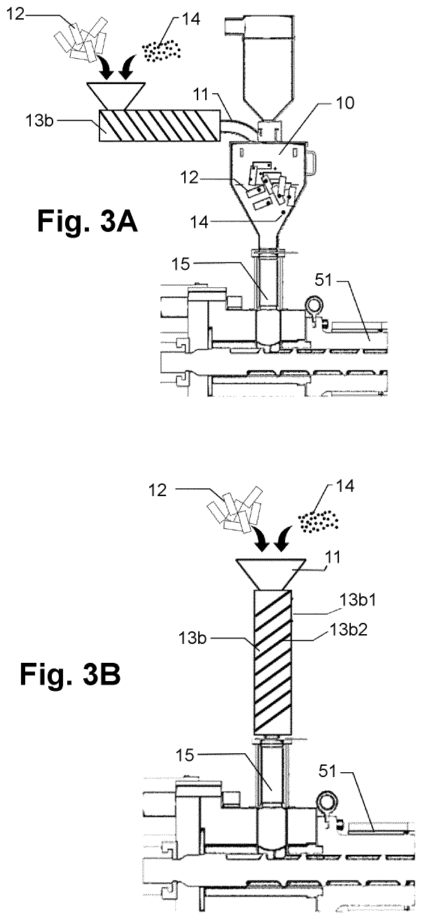

FIG. 3A shows a further schematic sectional view of an exemplary embodiment of a mixing conveyor according to the invention with a feed screw and a corresponding injection molding system (only partially shown);

FIG. 3B shows an alternative schematic sectional view of the mixing conveyor with a feed screw;

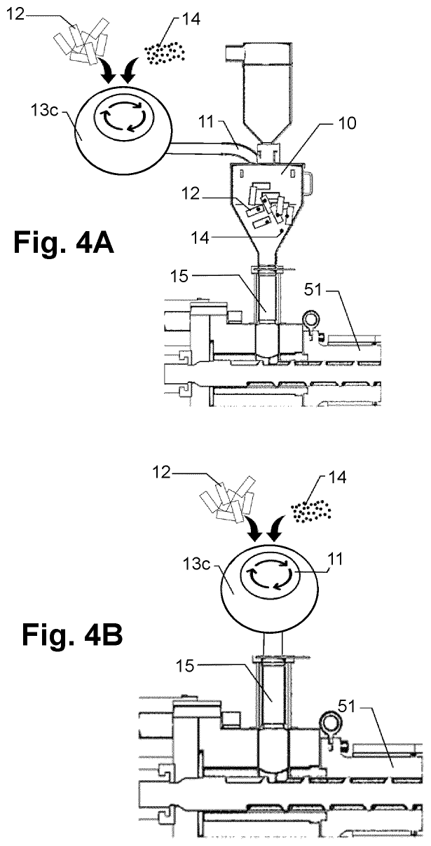

FIG. 4A shows a further schematic sectional view of an exemplary embodiment of a mixing conveyor according to the invention with a drum mixer and a corresponding injection molding system (only partially shown);

FIG. 4B shows an alternative schematic sectional view of the mixing conveyor with drum mixer;

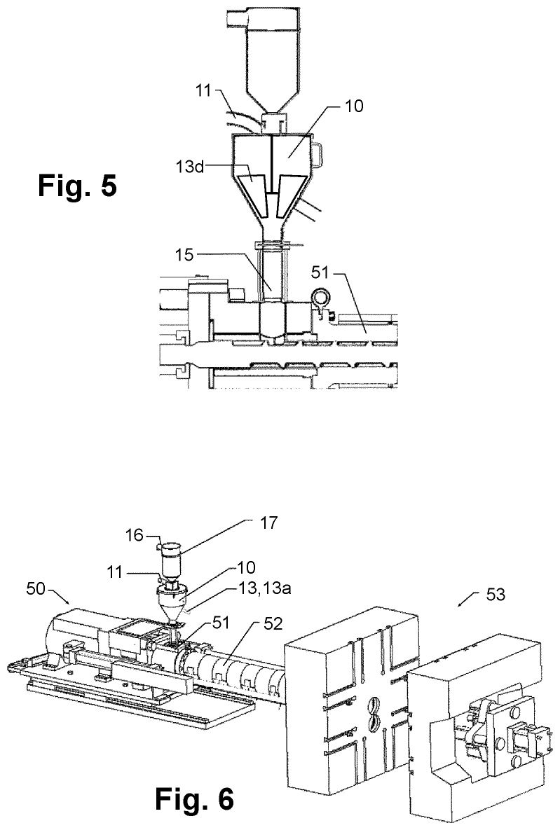

FIG. 5 shows a further schematic sectional view of an exemplary embodiment of a mixing conveyor according to the invention with an internal homogenization device and a corresponding injection molding system (only partially shown);

FIG. 6 shows a schematic representation of an exemplary embodiment of an injection molding system according to the invention with a clamping unit and two open halves of the molds;

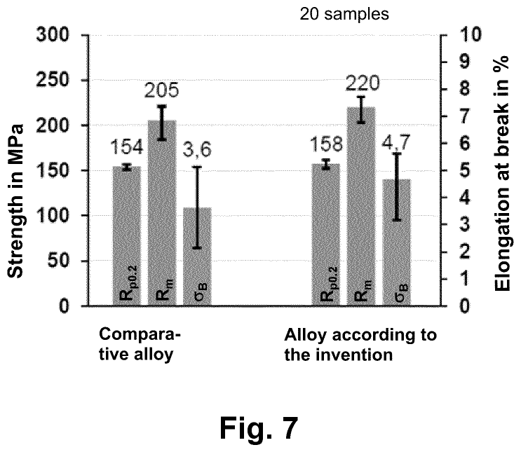

FIG. 7 shows a diagram comparing the strength and elongation at break properties of the alloy according to the invention and a reference alloy;

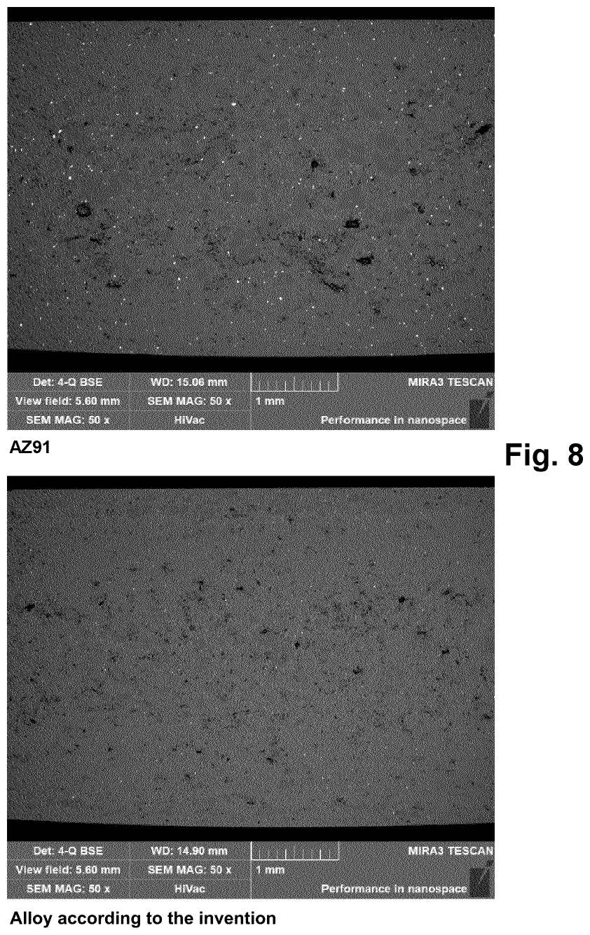

FIG. 8 shows a comparison of field emission scanning electron microscope images of the alloy according to the invention and a reference alloy;

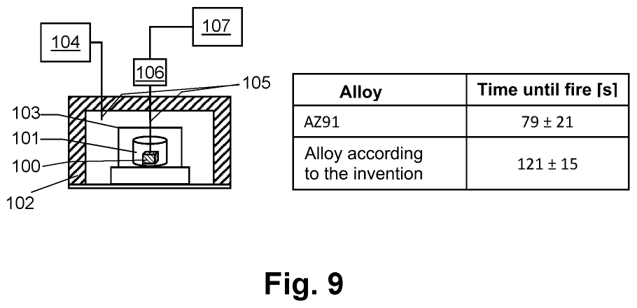

FIG. 9 shows a diagram comparing the fire properties of the alloy according to the invention and a reference alloy.

The figures are merely schematic in nature and are provided solely for the purpose of understanding the invention. Similar elements are provided with the same reference signs in the description of the exemplary embodiments.

FIG. 1A shows an exemplary embodiment of a mixing conveyor which is arranged on an injection molding system 50. In one exemplary embodiment, the injection molding system 50 can be designed as a thixomolding injection molding system.

The mixing conveyor has a mixing container 10, which is essentially cylindrical in an upper area and tapers in a funnel-like manner in a lower region towards an inlet area of the injection molding system 50. However, the geometry of the mixing container 10 is not limited to an essentially cylindrical shape and can deviate from this in alternative embodiments.

A first feed 11 for granular material 12 is arranged in the upper area of the mixing container 10.

In one exemplary embodiment, the granular material 12 comprises magnesium granules 12 and/or aluminum granules 12 and/or granules 12 comprising (further) alloying elements, such as one or more of aluminum, calcium, yttrium, zinc and manganese.

The granular material 12, which can be fed via the first feed 11, can be fed via lines (not shown) from a reservoir (not shown)—for example by suction or by pressurizing the granular material 14 or (purely) by gravity. For pressure equalization, the mixing conveyor has an air/gas outlet 16 and a filter 17.

Alternatively, according to an exemplary embodiment, the first feed 11 may comprise a feed screw (not shown) for conveying the granular material into the mixing container 10.

A second feed 13 for powdery material 14 is arranged in the lower region of the mixing container 10. In the exemplary embodiment according to FIG. 1A, the second feed 13 is designed as a powder feed nozzle 13a in order to inject the powdery material 14 into the interior of the mixing container 10. In this way, a moving or swirled granule-powder mixture of the granular material 12 and the powdery material 14 can be produced in the mixing container 10. In one exemplary embodiment, the powdery material 14 comprises carbon powder.

At a lower end of the lower region of the mixing container 10, the mixing container 10 has a mixing container outlet 15, which is arranged in the vicinity of a melting area 51 of the injection molding system 50. The mixing container outlet 15 is arranged and designed to feed the moving granule-powder mixture to the melting area 51 of the injection molding system 50 for (at least partial) melting. For this purpose, the swirled or moved granule-powder mixture preferably passes through the mixing container outlet 15 onto the moving screw 52 of the injection molding system 50 and thus remains in constant motion until (at least partial) melting at the location of the melting area 51.

In the exemplary embodiment shown in FIG. 1A, it can be seen that the powdery material 14 is injected at an angle to a flow of granular material 12 due to the arrangement or orientation of the powder feed nozzle 13a. This is also shown schematically in FIG. 1B for clarification. The first feed 11 and the second feed 13 are aligned relative to each other in such a way that a feed flow line L₁₂ of the granular material 12 (i.e. a path that the granular material 12 travels within the mixing container 10) and a feed flow line L₁₄ of the powdery material 14 (i.e. a path that the powdery material 12 travels within the mixing container 10) extend at an angle θ to each other within the mixing container 10. In the exemplary embodiment shown in FIG. 1, the angle θ between the powder and granule streams is approximately 120°. In alternative exemplary embodiments, the angle θ can be between 100° and 140°.

This enables the granular material 12 to be swirled within the mixing container 10 by a (lateral) directed impact of the powdery material 14 on the granular material 14 (slightly from below). In this way, the granular material and the powdery material mix particularly homogeneously to form a granule-powder mixture within the mixing container 10 and ultimately in the melting area 51.

In order to control a (respective) feed rate of the granular material 12 and/or the powdery material 14, the mixing conveyor or the injection molding system 50 may have corresponding means (not shown in FIG. 1A) for controlling a feed rate of the granules and/or the powder. This can be made possible, for example, by pressurizing the corresponding material with a gas or a gas mixture. The acceleration of the powdery material 14 is preferably achieved with compressed air, wherein an (impact) speed (on the granulate) can be set via different pressures. The use of gases and gas mixtures such as argon, for example, has also proven to be particularly favorable, whereby a particularly homogeneous mixing can be achieved and oxidation of the melt can be avoided or at least reduced. In addition, the use of appropriate gases or gas mixtures can also reduce or prevent the carbon particles from burning off.

A relative speed of less than 350 m/s between a granule feed flow and a powder feed flow within the mixing container 10 has proven in tests to be particularly advantageous in terms of homogeneity (at the location of the melting area 51) of the granule-powder mixture. A relative velocity of between 10 m/s and 100 m/s is particularly preferred. However, the relative velocity may vary depending on the particle or grain weight of the granules 12 and/or the powdery material 14.

In exemplary embodiments, the granular material 12 and/or the powdery material 14 can be (pre-) dried by means provided for this purpose (not shown).

FIG. 2A shows a schematic top view of a mixing container 10 according to an alternative exemplary embodiment with four powder feed nozzles 13a with a radial orientation (with respect to the mixing container). The powder feed nozzles 13a are arranged in a ring around the mixing container 10 or around a feed flow line L₁₂ (here into the drawing; see also FIG. 1B) of the granular material 12. The four powder feed nozzles are arranged evenly at 90° angular intervals. In further alternative embodiments, six powder feed nozzles 13a can also be arranged at 60° angular spacings or eight powder feed nozzles 13a at 45° angular spacings. As a result, the mixing of granular material 12 and powdery material 14 in the mixing container 10 can take place particularly uniformly (from all sides). In the case of multiple powder feed nozzles 13a, different or identical angles θ (see FIG. 1B) can be realized for each powder feed nozzle 13a.

FIG. 2B shows a further exemplary embodiment that is similar to the exemplary embodiment in FIG. 2A, but with the difference that the four powder feed nozzles 13a have a tangential orientation with respect to a peripheral wall of the mixing container 10. In this way, the powder flow also acts tangentially on the granulate flow. In this way, the mixing of the granule-powder mixture can be further optimized by the flow-induced turbulence. The angle θ (see FIG. 1B) can also be essentially 0° in this exemplary embodiment. Alternatively, the angle θ can also be greater than 0° when the powder feed nozzles 13a are aligned tangentially. Even in the case of tangential alignment of the powder feed nozzles 13a, the number of powder feed nozzles 13a is not limited to four. In alternative exemplary embodiments, the mixing container 10 may (also) have only one (or two or three) or a plurality of powder feed nozzle(s) 13a.

In a further exemplary embodiment (not shown), the mixing container 10 can have a flow guiding device that is designed to further optimize the mixing of the powder-granulate mixture. For example, ribs can be arranged on an inner wall of the mixing container, which influence the movement of the granular material 12 and/or powdery material 14 in order to optimize mixing.

In a further alternative exemplary embodiment (not shown), the mixing container 10 can have a housing that defines a helical passage from the first feed 11 for granular material 12 to an inlet of the injection molding system. Preferably, several powder feed nozzles can then be arranged along the helical passage in order to inject powdery material as described above. In this way, mixing can be (further) optimized (depending on the granules used).

FIG. 3A shows a schematic sectional view of a further exemplary embodiment of a mixing conveyor according to the invention with a feed screw 13b as a mixing device. The feed screw 13b can receive powdery material 12 and granular material 14 and mix these materials by an axial movement (rotation of the screw) of the material to be mixed (granules and powder) and simultaneously convey it towards the mixing container 10. In this exemplary embodiment, the granule-powder mixture is fed into the mixing conveyor 10 through the feed 11 at an axial end of the feed screw 13b.

Alternatively, multiple feed screws 13b can also be arranged on the mixing container 10 and connected to the mixing container 10 via a common or several feed lines 11.

In a further variant of the mixing conveyor according to the invention, the feed screw conveyor is arranged and designed in such a way that it (simultaneously) assumes the function of the mixing container and the mixing device—as shown by way of example in FIG. 3B. In this case, the casing (the conveyor housing) 13b1 of the feed screw 13b is preferably to be regarded as the mixing container 10 and the screw 13b2 of the feed screw 13b as the mixing device. In this exemplary embodiment, the axial output end of the feed screw 13b is designed as a mixing container outlet 15, which is arranged (or can be arranged) in the immediate vicinity of the melting area 51.

As can be seen from FIGS. 3A and 3B, the feed screw 13b can be arranged horizontally or perpendicularly to an extruder 52 (see FIG. 6). Alternatively, however, it is also conceivable that the feed screw 13b is arranged at an angle to the extruder 52.

FIG. 4A shows a schematic sectional view of an exemplary embodiment of a mixing conveyor according to the invention with a drum mixer 13c as mixing device. The drum mixer 13c preferably comprises a rotating drum, into which the powdery material 14 and the granular material 12 are introduced, and optionally one or more eccentrically arranged mixing tools (not shown) within the drum. The granule-powder mixture is preferably introduced into the mixing conveyor 10 via the feed 11 by opening a discharge opening or a discharge pipe (not shown) of the drum.

In a further variant of the mixing conveyor according to the invention, the drum mixer 13c e is arranged and designed in such a way that it (simultaneously) assumes the function of the mixing container and the mixing device—as shown by way of example in FIG. 4B. In this case, the drum of the drum mixer 13c is preferably to be regarded as the mixing container 10 and a drive or a mixing tool of the drum mixer 13c as the mixing device. In this exemplary embodiment, the discharge opening or a discharge pipe of the drum mixer 13c is designed as a mixing container outlet 15, which is arranged (or can be arranged) in the immediate vicinity of the melting area 51.

For the other features of the exemplary embodiments of FIGS. 3A, 3B, 4A, 4B, reference is made to the description in connection with the exemplary embodiments of FIGS. 1A, 1B, 2A and 2B.

FIG. 5 shows an exemplary embodiment of the mixing conveyor according to the invention, according to which a homogenizing device 13d is arranged as a mixing device inside the mixing container 10. In this exemplary embodiment, the homogenizing device 13d is designed as a stirring hook which can homogenize (stir) an introduced granule-powder mixture inside the mixing container 10 in order to counteract segregation of the granule-powder mixture. The homogenizing device 13d can advantageously be combined with other mixing devices 13a, 13b, 13c, as shown, for example, in FIGS. 1A, 3A, 4A.

FIG. 6 shows an exemplary embodiment of an injection molding system 50 with a mixing conveyor as described above in connection with FIG. 1A. However, the following explanations apply analogously to alternative embodiments of the mixing conveyor (as described above).

The mixing container 10 or the mixing container outlet 15 of the mixing conveyor is arranged in the vicinity of the melting area 51 of the injection molding system 50, so that the granule-powder mixture can be fed to the melting area 51 immediately after/during mixing.

The (at least partially) melted granule-powder mixture is conveyed and sheared through a heated extruder 52 by means of a rotary movement of an extruder screw. In the process, the melt is further heated and, optionally, completely melted. A corresponding rotary movement can increase heat transfer by convection in order to accelerate melting. The molded article is formed by an axial movement of the screw, which presses the melt into a clamping unit 53 (shown open). The clamping unit 53 is designed to move two halves of the mold of the injection molding system 50.

In one exemplary embodiment, the molded article molded with the injection molding system 50 is made of an alloy comprising:
0.1% by weight to 5.0% by weight carbon (C), preferably 0.2% by weight to 4.0% by weight carbon (C), more preferably 0.5% by weight to 3.5% by weight carbon (C);
1.0% by weight to 10% by weight aluminum (Al);
0.1% by weight to 2.0% by weight calcium (Ca);
0.05% to 2.0% by weight of yttrium (Y);
optionally more than 0.0% by weight and up to 0.002% by weight of beryllium (Be);
optionally more than 0.0% by weight and up to 6.0% by weight zinc (Zn);
optionally more than 0.0% by weight and up to 1.0% by weight of manganese (Mn); and
a balance of magnesium (Mg) and a residue of unavoidable impurities.

To produce the molded article consisting of the above alloy according to the method of the invention, the carbon component (C) and/or the calcium component (Ca) is fed to the mixing container 10 as powdery material 14.

The remaining alloy components are (in each case) introduced into the mixing container 10 by one or more types of granular material 12 through the first feed 11. The granular material 12 may comprise a granular mixture comprising different granular particles of different substances or compositions of substances. For example, one (or more) material component(s) of the alloy of the molded article may be added by a first granulate in each case and the remaining components of the alloy by a second (and/or a further) granulate.

An exemplary material composition of a molded article of the alloy according to the invention is listed below in Table 1. The mechanical properties of the molded article according to the invention are also compared with a molded article of an alloy without carbon content.

The alloys in Table 1 were cast into ingots, which were then mechanically shredded into granules. The individual components were determined by weighing. The alloy according to the invention was produced according to the method according to the invention, as described above. The comparative alloy was essentially analogous to this, wherein no carbon content was added.

TABLE 1

| | Alloy according | |
|---|---|---|
| | to the invention | Comparative alloy |
| Material | [% by weight] | [% by weight] |
| Carbon (C) | 0.15 | — |
| Aluminum (Al) | 8.8 | 8.8 |
| Zinc (Zn) | 0.6 | 0.6 |
| Manganese (Mn) | 0.14 | 0.14 |
| Calcium (Ca) | 0.29 | 0.29 |
| Yttrium (Y) | 0.16 | 0.16 |
| Beryllium (Be) | 0.0012 | 0.0012 |
| Magnesium (Mg) | as a balance to | as a balance to |
| | 100% by weight | 100% by weight |

As can be seen from the diagram in FIG. 7, the yield strength (or elongation at break) σ_{B} was increased from 3.6% to 4.7% by the carbon content. This corresponds to an increase of approx. 25%. Overall, it could therefore be shown that the addition of carbon significantly improves the mechanical properties of the alloy or the molded part. In addition, the tensile strength Rₘ was significantly increased compared to the reference alloy (by approx. 7%).

The yield strength Rp_{0.2} of the alloy according to the invention could also be increased compared to the reference alloy without the carbon content.

Here, the parameters of the diagram in FIG. 7 were determined by means of a tensile test on tensile specimens (DIN6892-1). The elongation at break here indicates the elongation of tensile specimens until breakage, in relation to the initial length.

The parameters were averaged over the measurements of 20 molded article samples.

The improvement in the mechanical properties of the alloy according to the invention is achieved in particular by the addition of the carbon powder, which causes a fine grain of the alloy or the molded article by reacting with the aluminum from the alloy, or the addition of the particles results in reduced porosity in the molded article and fewer or more finely distributed gas inclusions. This can also be seen in a comparison of an AZ91 alloy and the alloy according to the invention in a field emission scanning electron micrograph, as shown in FIG. 8.

Higher carbon contents in alternative embodiments of the alloy according to the invention or the molded article can be realized by the method according to the invention (e.g. more than 3% by weight and less than 5.0% by weight or more than 3.5% by weight and less than 5% by weight). This can be weighed against mechanical properties such as tensile strength, depending on the need or requirement for flame resistance.

The flame resistance of the magnesium alloy according to the invention (according to Table 1) was compared with the conventional magnesium alloy AZ91. For this purpose, a sample 100 each of the alloy according to the invention and AZ91 was heated in a ceramic container 101 in a furnace 102 under identical conditions until the samples 100 ignited (see FIG. 9).

The identical conditions were ensured by an oven protection shield 103 and a heating control 104 with a thermal sensor 105.

The moment of ignition of the samples 100 was measured via a further thermal sensor 105 for the respective sample 100, which is connected to a data acquisition module 106 and a computer for data evaluation 107.

TABLE 2

| Alloy | Time until fire [s] |
|---|---|
| AZ91 | 79 ± 21 |
| Alloy according | 121 ± 15 |
| to the invention | |
| (from Table 1) | |

In this way, it was measured (by averaging multiple samples 100) that the time for ignition could be significantly increased with the magnesium alloy according to the invention compared to the conventional AZ91 magnesium alloy. The results are shown in Table 2.

### LIST OF REFERENCE SIGNS

10 Mixing container of the mixing conveyor
11 First feed
12 Granular material (granules)
13 Second feed
13a Powder feed nozzle
13b Feed screw
13b1 Feed casing of the feed screw
13b2 Screw of the feed screw
13c Drum mixer
13d Homogenizing device (stirring hook or stirring blade)
14 Powdery material (powder)
15 Mixing container outlet
16 Air/gas outlet
17 Filter
50 Injection molding system
51 Melting area
52 Extruder with extruder screw or injection unit (screw is axially movable)
53 Clamping unit with mold halves
L₁₂ Feed flow line of the granules
L₁₄ Feed flow line of the powder
θ Angle between L₁₂ and L₁₄
100 Alloy sample
101 Ceramic container
102 Furnace
103 Oven protection shield
104 Heating control
105 Thermal sensor
106 Data acquisition module
107 Computer for data acquisition

1. Mixing conveyor for an injection molding system, in particular a thixomolding injection molding system, or the like for conveying a granule-powder mixture, comprising the following:
a mixing container (10), with at least one feed (11, 13) for granular material (12) and/or powdery material (14); and
at least one mixing device (13a, 13b, 13c, 13d) which is designed to mix the granular material (12) and the powdery material (14) to form a granule-powder mixture; and
a mixing container outlet (15), which can be arranged in particular in the vicinity of a melting area (51) of the injection molding system (50) or the like, and is designed to discharge the granule-powder mixture or to feed it to the injection molding system (50) or the like for at least partial melting.

2. Mixing conveyor according to claim 1, characterized in that the mixing device (13a, 13b, 13c, 13d) is designed to mix the granular material (12) and the powdery material (14) into a granule-powder mixture by means of a repetitive movement of the granular material (12) and the powdery material (14).

3. Mixing conveyor according to claim 1, characterized in that the mixing device (13a, 13b, 13c, 13d) is designed to mix the granular material (12) and the powdery material (14) by means of a gas-induced flow to form a granule-powder mixture.

4. Mixing conveyor according to claim 1, characterized in that the mixing device (13a, 13b, 13c, 13d) is designed to mix the granular material (12) and the powdery material (14) by a rotational movement to form a granule-powder mixture.

5. Mixing conveyor according to claim 1, characterized in that the mixing device (13a, 13b, 13c, 13d) comprises a powder feed nozzle (13a), wherein the mixing container (10) has a first feed (11) for granular material (12) and a second feed (13) for powdery material (14), wherein the second feed (13) has the powder feed nozzle (13a), and wherein the powder feed nozzle (13a) is designed in particular to inject the powdery material (14) into the mixing container (10) in such a way that a flow-induced granule-powder mixture can be produced in the mixing container (10) in order to mix the granular material (12) and the powdery material (14) with one another.

6. Mixing conveyor according to claim 5, characterized in that the first feed (11) and the second feed (13) are aligned relative to one another in such a way that a feed flow line (L₁₂) for the granular material (12) and a feed flow line (L₁₄) for the powdery material (14) run inside the mixing container (10) at an angle (θ) to one another.

7. Mixing conveyor according to claim 1, characterized in that the mixing device (13a, 13b, 13c, 13d) comprises a feed screw (13b) which is designed to receive the granular material (12) and the powdery material (14) and to mix them to form a granule-powder mixture.

8. Mixing conveyor according to claim 1, characterized in that the mixing device (13a, 13b, 13c, 13d) comprises a drum mixer (13c) which is designed to receive the granular material (12) and the powdery material (14) and to mix them to form a granule-powder mixture.

9. Mixing conveyor according to claim 1, characterized in that the mixing device (13a, 13b, 13c, 13d) comprises a homogenizing device (13d) which is arranged inside the mixing container (10) and which is designed to homogenize the contents of the mixing container (10), preferably by rotating a stirring blade or a stirring hook or the like.

10. Injection molding system for (light) metal alloys, preferably a thixomolding injection molding system, comprising:
a mixing container (10), with at least one feed (11, 13) for granular material (12) and/or powdery material (14); and
at least one mixing device (13a, 13b, 13c, 13d) which is designed to mix the granular material (12) and the powdery material (14) to form a granule-powder mixture; and
a mixing container outlet (15) arranged in the vicinity of a melting area (51) of the injection molding system (50) and is designed such that the granule-powder mixture can be melted immediately after mixing and/or at least partially during mixing.

11. Method for producing a molded article with a thixomolding injection molding system, wherein the method comprises the following steps of:
a) carrying out a mixing process in which at least one granular material (12) comprising magnesium and/or aluminum or an alloy thereof and at least one powdery material (14) are mixed in a mixing device (13a, 13b, 13c, 13d) to form a granule-powder mixture;
b) feeding the granule-powder mixture into a mixing container (10) of the injection molding system;
c) at least partial melting of the granule-powder mixture in a melting area (51); and
d) injection molding of the molded article from the at least partially melted granule-powder mixture.

12. Method according to claim 11, characterized in that the granular material (12) and the powdery material (14) are mixed in step a) and/or b) by a repetitive movement of the granular material (12) and the powdery material (14) to form a granule-powder mixture.

13. Method according to claim 11, characterized in that at most 120 seconds, preferably at most 60 seconds, lie between (the end of) step a) and (the start of) step c).

14. Method according to claim 11, characterized in that the powdery material (14) is injected into the mixing container (10), or into at least a partial region of the mixing container (10), for flow-induced mixing of the powdery material (14) with the granular material (12) by means of at least one powder feed nozzle (13a).

15. Method according to claim 14, characterized in that a relative feeding speed between the granular material (12) and the powdery material (14) is between 0.5 m/s and 500 m/s, preferably between 1 m/s and 200 m/s, more preferably between 10 m/s and 100 m/s.

16. Method according to claim 14, characterized in that the powdery material (14) is injected against a flow of granular material (12) and/or at an angle (θ) to the flow of granular material (12).

17. Method according to claim 11, characterized in that the powdery material (14) and the granular material (12) are mixed in step b) and/or step a) in a feed screw conveyor (13b).

18. Method according to claim 11, characterized in that the powdery material (14) and the granular material (12) are mixed in step b) and/or step a) in a drum mixer (13c).

19. Method according to claim 11, characterized in that the powdery material (14) and the granular material (12) are mixed in step b) and/or step a) with a homogenizing device (13d) inside the mixing container (10).

20. Method according to claim 11, characterized in that the mixing process comprises an external mixing process outside the mixing container (10) and a second internal mixing process inside the mixing container (10).

21. Method according to claim 11, characterized in that step c) follows immediately after steps a) and b), and/or steps a) to c) are carried out simultaneously for corresponding partial quantities of the granule-powder mixture and/or the granule-powder mixture reaches the melting area (51) in a moving state.

22. Method according to claim 11, characterized in that the powdery material (12) comprises at least one of carbon powder, carbon powder mixtures, carbon compounds or calcium powder.

23. Method according to claim 11, characterized in that the powdery material (12) has a particle size of between 10 nm and 25 nm.

24. Method according to claim 11, characterized in that the mixing process of step a) comprises the following:
providing the granular material (12), wherein the granular material (12) comprises granules consisting of the following:
1.0% by weight to 10% by weight aluminum (Al);
0.1% by weight to 2.0% by weight calcium (Ca);
0.05% by weight to 2.0% by weight yttrium (Y);
optionally more than 0.0% by weight and up to 0.002% by weight beryllium (Be)
optionally more than 0.0% by weight and up to 6.0% by weight zinc (Zn);
optionally more than 0.0% by weight and up to 1.0% by weight manganese (Mn); and
a balance of magnesium (Mg) and a residue of unavoidable impurities;
providing the powdery material (14), wherein the powdery material comprises carbon powder (C), preferably in an amount between 0.1 to 5.0% by weight of the total weight of the components of powdery material (14) and granular material (12);
Mixing the granules and the carbon powder to form the granule-powder mixture.

25. Method of claim 11 wherein the molded article is made of an alloy, the alloy comprising:
0.1% by weight to 5.0% by weight carbon (C), preferably 0.2% by weight to 4.0% by weight, more preferably 0.5% by weight to 3.5% by weight carbon (C);
1.0% by weight to 10% by weight aluminum (Al);
0.1% by weight to 2.0% by weight calcium (Ca);
0.05% by weight to 2.0% by weight yttrium (Y);
optionally more than 0.0% by weight and up to 0.002% by weight beryllium (Be)
optionally more than 0.0% by weight and up to 6.0% by weight zinc (Zn);
optionally more than 0.0% by weight and up to 1.0% by weight manganese (Mn); and
a balance of magnesium (Mg) and a residue of unavoidable impurities.

26. Method according to claim 25, characterized in that the alloy or the molded article has a tensile strength (Rₘ) of at least 210 MPa, preferably at least 220 MPa and/or an elongation at break (σ_{B}) of at least 3.5%, preferably at least 4%, more preferably at least 4.5%.
